(19) United States
(12) Patent Application Publication
(10) Pub. No.: US 2020/0104430 A1
(43) Pub. Date: Apr. 2, 2020

(54) VIRTUALIZED COMPUTER-AIDED DESIGN

(71) Applicant: AECLInX, LLC, Marietta, GA (US)

(72) Inventors: George Haddad, Atlanta, GA (US); Mark Axford, Atlanta, GA (US); Richard Burroughs, Atlanta, GA (US)

(21) Appl. No.: 16/575,087

(22) Filed: Sep. 18, 2019

Related U.S. Application Data
(60) Provisional application No. 62/732,601, filed on Sep. 18, 2018.

(51) Int. Cl. G06F 17/50; G06F 9/455; G06F 11/34

(52) U.S. Cl. CPC G06F 17/50; G06F 2217/04; G06F 11/3438; G06F 9/45558

(57) ABSTRACT

Systems and methods presented herein virtualize computer-aided-design (“CAD”). A licensing server stores designer profiles, allowing customers to select a designer by availability and experience factors for working on a project. The designer can then login and control a virtual machine (“VM”) configured for the project. The system can allocate a license to an application within the VM, allowing the designer to use the VM without purchasing the full license. The customer can separately log in and be presented with access to a project folder.

### CROSS-REFERENCE TO RELATED APPLICATIONS

This non-provisional application claims priority to provisional application No. 62/732,601, titled “Virtualized Computer-Aided Design,” filed Sep. 18, 2018. Application No. 62/732,601 is also incorporated by reference in its entirety.

### BACKGROUND

Architecture, engineering, and construction projects commonly rely on computer-aided design (“CAD”). For example, a designer can use CAD software to visualize complex structures or parts, often creating a model that is used as a guide for ordering materials and performing construction. As an example, AUTODESK REVIT is Building Information Modeling (“BIM”) software that allows users to elaborately design three-dimensional structures. REVIT can be used to design complex buildings all the way down to components and assemblies for use in a project. For example, a user can model an entire plumbing or electrical installation within a building. BIM and CAD systems also include related software-based project tools.

However, as a customer that needs BIM or CAD work done, finding local talent can be difficult. Many designers work for large firms and are already involved in projects. This can require the customer to set forth a large retainer or pay high rates, even when a one-off project may not otherwise require it.

Additionally, the designers themselves often desire to work as contractors but lack the means to do so. While working independently or remotely is attractive, the designers may lack a way to attract customers. Additionally, the designers may be required to purchase software licenses even when they do not yet have projects or know which licenses are required. A license to BIM software can be expensive. In addition, the system can require advanced hardware and networking to allow a user to render a model in a BIM or CAD application. A designer might not be able to justify the costs when they do not have a heavy workload.

Finally, companies that staff many designers, such as engineering or architectural firms, often need a way to efficiently scale their workforce. If they hire too many designers, payroll is larger than it needs to be. Conversely, if too many projects come in, it may be difficult to quickly staff up to meet the needs of the customer.

Therefore, a need exists for a system that virtualizes CAD, including providing shared licensing and hardware for CAD applications.

### SUMMARY

The examples described herein specifically address technical problems and limitations of CAD applications, such as REVIT and other BIM software. The system can include a licensing server that delegates licenses to designers based on active projects and instantiates a virtual machine (“VM”) where the CAD application executes based on the delegated license. The licensing server can be cloud-based. In one example, the licensing server can connect buyers and designers virtually, allowing designers flexibility without requiring massive investment in licensing and hardware.

In one example, a user (also called a “customer”) can select CAD project requirements on a graphical user interface (“GUI”) associated with the system. This can include making selections to specify project requirements and types of assistance needed. For example, the user can describe the type of construction or design, the type of engineer needed, or permitting that will be required. This can relate to the type of CAD designer needed. For example, the GUI can allow the customer to choose a project type and a designer (or designer type) for the project. The GUI can be part of an application or web interface that executes on the client device. In one example, a customer can specify a project using the GUI.

In one example, a customer can build a profile that is stored in the system. The customer profile can indicate project requirements, such as required terms and conditions for one or more particular projects. The customer profile can also contain company credentials to allow potential designers to validate the company's legitimacy prior to taking on a project. The customer profile can also include payment terms and method of payment, in an example.

A licensing server can receive the project requirements and determine potential designers needed by the user to meet those options. For example, the server can match one or more of the requirements against designer profiles. The designer profiles can represent skill sets and licenses that a designer has. In one example, the designer saves a designer profile to the licensing server. The designer profile can indicate skills, rates, certifications, and experience. The designer profile can also indicate designer availability. In one example, the designer can also specify their rate. The system may alter the rate actually presented to a customer, for example, to build in profit to the system itself. The designer can also be referred to herein as an expert.

The system can suggest designers or designer types based on the requirements received from the user (i.e., customer), such as project type, designer type needed, start date, and budget. In one example, the licensing server sends designer options, which can be a list of matching designers, for display on the user device. The designer options can be compiled based on matching the requirements against stored designer profiles. This can include required credentials, experience with the project type, availability, and rates, among other things. The designer rates can be increased from those in the designer profile to allow for profit.

The GUI can allow the customer to whitelist or blacklist designers from within the designer options. Alternatively, the GUI can allow the customer to select a single designer for each type required by the project. The selected designer options can then be sent to the licensing server.

Based on receiving selected designer options, the licensing server can create a project that is assigned to the customer and a designer. The project can be, for example a REVIT project that is stored in the cloud. The project can be accessed by both the customer and the one or more selected designers. In one example, the server can assign the customer and the selected designer to a project folder. The licensing server can also electronically notify the selected designer. The designer can be given an opportunity to accept or deny working on the project, in an example.

When the designer logs in to work on the project, the licensing server can instantiate a virtual machine (“VM”) that has access to the project (such as the files in the project folder). The VM can execute in the cloud, such as on the licensing server, in an example. However, the graphics can display on the designer's computing device, allowing the designer to use the application without needing expensive hardware.

The VM can be configured to execute an application that is chosen based on a project type of the project. For example, a particular version of REVIT with add-on functionality can be chosen for a first project type, whereas a different CAD program can be chosen for a second project type. A table at the licensing server can map different applications to different project types. In this way, the licensing server can use the project type to determine which virtual machine configuration (including which applications) to use.

Additionally, an available license can be allocated to the designer while the designer is logged into the VM. The VM can execute at least one of the applications based on the allocated license. Based on the designer login, the licensing server can allocate an available license(s) to the VM for running the application(s). Then, when the designer logs out, the licensing server can deallocate the license from use with the VM. In this way, licenses can be minimized by distributing them according to actual use. Designers can, in effect, share licenses. This can allow designers to perform work without the burden of owning a full license themselves. Licenses can be distributed according to project type while also minimizing the total licenses needed.

Although REVIT is referred to throughout this disclosure as an example, the disclosure applies to any BIM or CAD application.

It is to be understood that both the foregoing general description and the following detailed description are exemplary and explanatory only and are not restrictive of the embodiments, as claimed.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is an exemplary flow chart of stages performed by a system;

FIG. 2 is an exemplary sequence diagram of stages performed by a system;

FIG. 3A is an example illustration of a GUI;

FIG. 3B is an example illustration of a GUI; and

FIG. 4 illustrates exemplary system components.

### DESCRIPTION OF THE EXAMPLES

Reference will now be made in detail to the present exemplary examples, including examples illustrated in the accompanying drawings. Wherever possible, the same reference numbers will be used throughout the drawings to refer to the same or like parts. The described examples are non-limiting.

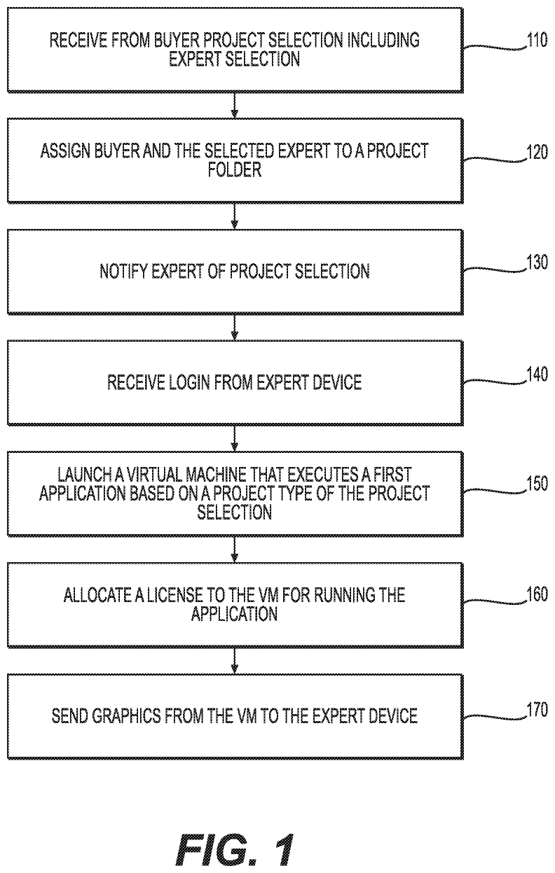

FIG. 1 includes an exemplary flow chart for virtualizing CAD, in an example. The system can connect customers with designers in a way that distributes licenses more efficiently. A customer can connect to a licensing server that provides a virtual project environment. The licensing server can be cloud-based, in an example. The licensing server can generate a console that provides both the customer and designers access to the project environment. The customer can log into the system. The server can store a customer profile that can be used to present information about the customer to designers. Designers, likewise, can create designer profiles that allow the customer to see information about the designers. The licensing server can be multi-tenant in an example, storing information and providing virtual project environments for multiple different customers and designers alike. Both profile types can be used by the licensing server to efficiently match designers to customer projects, as will be explained below.

The licensing server can create a project to which matching customers (i.e., users) and designer(s) are assigned. Then, when a designer logs into the system to access the project, the licensing server can start a VM. The VM can have access to the project folder with saved files for the project. The VM can also be configured to run one or more applications assigned to the project type. Licenses can be temporarily assigned based on those applications and the uses needed for the project type. This can allow the designer to use the applications based on either their own licenses or shared licenses distributed by the system. When the designer logs out of the project, the licenses can be reallocated.

At stage 110, the licensing server can receive selections from a customer device related to designer selection. The designer selection can be made based on creating a new project and making selections of designer options. For example, a GUI can present possible project requirements and the user can select which ones apply. This can include defining what type of plan the user desires. The user can select between a house plan, office plan, remodel plan, structural support plan, and landscape plan, among others. This can be one of several project requirements presented on a GUI. Other project requirements can include maximum cost and project timeframe. In yet another example, the user can select a designer type as one of the project requirements. Designer types can include, for example, an architect, structural engineer, or other expert types. The user can make these selections on the GUI, which can be generated from a remote console or on application on the user device.

In one example, the licensing server assists with designer selection based on the type of designer needed for the project. The project requirements can be associated with one or more particular designer types or can include selections of designer type. Designers meeting the requirements, such as designer type, price, and timeframe availability, can be identified by the licensing server based on comparisons with the designer profiles. Designers can be engineers, architects, or other design experts. In one example, a GUI allows the customer to select the type of designer as a project requirement. The customer can further select availability, rates, specific skills, and type of work the designer will perform. These selections can be compared against designer profiles stored at the licensing server to determine eligible designers. A designer profile can include the designer's rates, skills, certifications, experience, and availability. The system can filter potential designers based on other factors also, such as the geographic location of the designer compared to the customer.

Eligible designers can then be displayed on the GUI. The customer can then select one or more designers to add to the project. In one example, the customer can rank multiple potential designers for a single position. The licensing server can then contact the designers in order, based on contact information in the designer profiles. If a designer denies the project request, then the licensing server can contact the next designer based on rank. In another example, the user can then select one or more designers that are acceptable or that should be excluded from the project.

Based on receiving a selection from the designer options, the licensing server can create a project that is assigned to the customer and a designer at stage 120. The licensing server can track which projects are associated with the customer and allow the customer to add a designer to one ore more of those associated projects. The projects can be part of the customer profile. At stage 120, the selected designer is assigned to the project. If the customer is not already assigned to the project, the system can do so at this stage. The licensing server can provide both the buyer and designer with access to a project folder. The server can track which customers and designers are associated with which projects and grant access to project folders based on those associations. The associations can be stored locally or in an accessible database.

At stage 130, the licensing server can notify the designer that they have been assigned to the project. To do this, the server can use contact information in the selected designer's profile. For example, the notification can be sent as an email, text, or automated call to a designer device. The contact information for the designer device can be included in the designer profile. In another example, designers must confirm their willingness to work on the project at stage 130 before the system assigns the designer to the project at stage 120.

Similarly, the licensing server can notify the customer regarding changes to the project. The customer can be notified when a designer accepts assignment, makes changes to the project, or submits an invoice, in an example.

At stage 140, the designer can log into the licensing server. Upon verifying the designer or designer device, the server can instantiate a VM at stage 150. The VM can present a designer with a workspace environment configured to include applications needed by the designer. The applications can be based on the project type, designer type, licenses assigned to the project by the customer or designer, or applications specified in the customer or designer profile. In one example, a project type is associated with each project. The project type could be, for example, a BIM model or a CAD drawing. For each project type, the VM configuration can include one or more applications that will be needed. The VM can, therefore, launch with one or more applications based on one or more projects assigned to the designer. The VM can only allow launch of an application with respect to a particular project, in an example. This can prevent the designer from using the application to work on other projects where the application is not licensed or assigned. Alternatively, restricting the designer to saving all output in the project folder can also act as a deterrent against unauthorized use, since the customer can view files the designer saves in an example.

The VM can execute on the licensing server or in the cloud. This means the designer device need not have the hardware required to execute the one or more applications, which are often CAD or BIM applications. Instead, the VM executes these applications remotely on a server meeting the technical requirements. This can allow the designer to work, for example, from a laptop, phone, other computing device. Previously, designers have been limited from doing freelance work based on the technical requirements for properly operating CAD and BIM applications. Offloading that to a server can free up designers to the benefit of both designers and customers.

At stage 160, the licensing server can allocate a license to the VM for running the application. To the extent multiple licenses are required for multiple applications in the VM, those can all be allocated. The allocation can occur as part of VM instantiation in one example. Alternatively, allocation can occur when a particular application is opened. The application can include a wrapper to call back to the licensing server from the VM for the allocation, in an example. This callback can include a designer identifier and application identifier, which can be used by the licensing server to allocate the correct license. The licensing server can log timings of license allocations for future evaluation.

The license allocation can be timed, and the designer can be charged for their use accordingly. In one example, the usage of the license is billed against the designer's hourly rate. When a customer pays a bill, a portion can go towards covering the licensing cost while the rest goes towards the time spent by the designer. The time spent can be tracked by the VM or licensing server and made available for review in the project folder.

In one example, the customer can provide a paid-for license to the project for use by the designer. The customer can use the console GUI to select and upload tokens to system. The customer can allocate one or more licenses to a project. This can allow the selected designer(s) to use the customer licenses, in an example. Doing so can reduce the costs owed by the customer for the project, in an example. For example, the license can be billed at a lower amount against the designer's hourly rate. This can allow the customer to save money while still allowing profit for the system, in an example.

In another example, the designer can provide one or more of their own licenses. For example, if the designer already has a license to a BIM software, then the designer can select the license file(s). The designer device can transmit a token with the license information embedded. The token can be received by the licensing server and stored with the designer profile, in an example. This can allow the VM to use the designer's license and not bill the designer for use of that license, in an example.

In one example, when the customer or designer logs in, a GUI option is available for them to input license information or upload the token. The GUI can also allow the designer to mark their license as sharable. In that case, the license can be allocated to other designers by the licensing server when the designer is not logged in. The designer can be paid a portion of the money charged to other designers for use of the license. However, the license can also be unavailable to the designer while another designer is using it.

Once the license is allocated, the VM can execute the application. At stage 170, the designer device can display the VM, even though the VM can execute remotely on different hardware. The VM can provide a desktop environment, allowing the designer device to click through a folder substructure in the project folder. The designer device can be any processor-based device, such as a personal computer, laptop, tablet, or a phone. Whereas some of these devices have been incapable of running the CAD or BIM applications needed for the CAD project, these devices are capable of receiving and displaying the graphics while the VM runs the applications in the cloud.

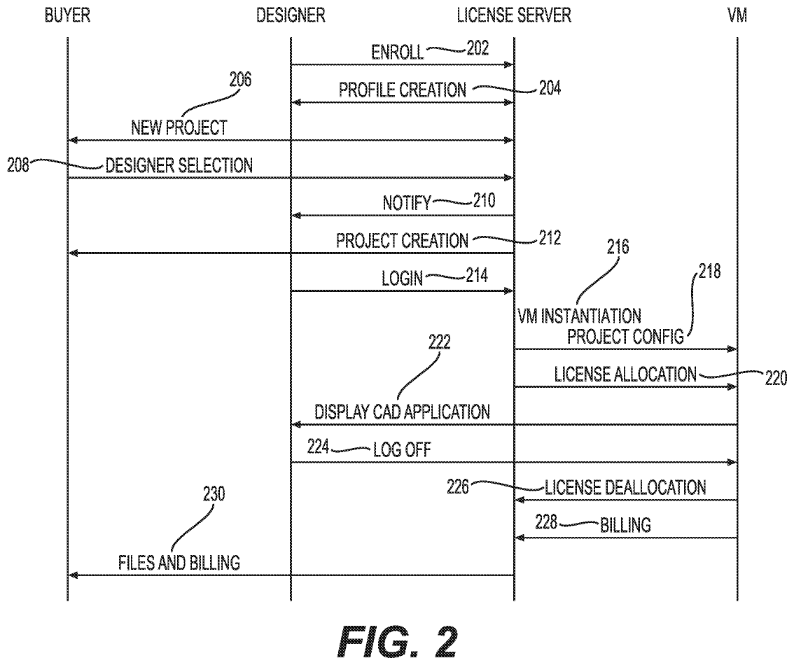

FIG. 2 is an exemplary sequence diagram. At stage 202, the designer can enroll with the CAD virtualization system. This can include enrolling with the licensing server (labelled as license server in FIG. 2). As part of enrollment, the licensing server can create a designer profile at stage 204. To do this, the licensing server can prompt the designer for several pieces of information, such as rate, project type, availability, or any other factors stored in the designer profile.

The designer can also opt to provide one or more licenses of different types of applications at this stage. For example, if the designer selects their specialties or project types, the GUI can list the pool of applicable applications. The GUI can also include an option for providing licenses for use on the system, such as by entering licensing information or providing a token. The GUI can indicate which of the applications the license applies to. This can visually show the designer which applications they will be charged for versus which ones will use their own license.

At stage 206, a customer (i.e., user) can create a new project. This can include accessing a VM that presents a GUI in one example. Alternatively, it can be done by the customer device communicating with the licensing server, such as through an application or web interface. The licensing server can associate the project with the customer for later retrieval. The licensing server can also retrieve designers to recommend for the project. This can be based on matching project requirements to designer profiles. For example, the user can select particular designer types that are needed for the project. Alternatively, the project type itself can be associated with designer types by the licensing server.

At stage 208, the customer can select a designer to add to the project. This can be done as part of new project creation or separately, afterwards. The licensing server can recommend designers based on the customer's criteria. For example, the design profiles can indicate which designers have matching skillsets and availability. In one example, the customer selects more than one approved designer. This can allow the licensing server to communicate with multiple designers without needing further approvals from the customer. This can include contacting designers in a ranked list until one accepts the project.

At stage 210, the licensing server can notify the designer that they have been nominated for or added to a project. To do this, contact information from the designer device can be retrieved from the designer profile of the selected designer. The contact information can include email, phone number, or instant messaging identifier. In one example, the designer can reply with an acceptance, causing the licensing server to finalize the designer selection. Similarly, the buyer can be notified of the selection.

Once a project has at least one designer assigned to it, the system can notify the designer and customer that the project is ready for work at stage 212. The licensing server can create a folder for the project. The server can grant folder access to the customer and designer.

Thereafter, at stage 214, the designer can log into the licensing server to access the project. The login can cause the licensing server to instantiate a VM at stage 216. The system can instantiate the VM with a configuration at stage 218 that includes the needed applications. The applications, such as CAD or BIM applications, can require a license. Additionally, the VM can execute based on credentials for the customer or designer, allowing the VM to access the project folder.

At stage 220, the licensing server can allocate license for use at the VM. These licenses can belong to the designer, customer, or can be shared licenses belonging to the system. In one example, tokens in the design profile can be used to indicate which licenses to allocate for which applications. These tokens can indicate the customer's or designer's own licenses. Alternatively, if the designer does not have their own license, a shared license can be allocated. The shared license usage can be timed, and the customer can be charged for that time. In one example, the customer can achieve a lower rate per hour by choosing to use their own license.

In one example, licenses are allocated when the VM is instantiated. A startup process can retrieve licenses based on the VM configuration, which dictates which applications are loaded on the VM. If licenses are unavailable for an application, it can be either omitted from the VM or disabled within the VM.

The designer can open a project folder within the VM. The project folders available can be based on which project folders are assigned to the designer at the licensing server. The designer can also open one of the applications and select the project. This activity can be displayed at stage 222 on the designer device. However, the VM can execute remotely, on the licensing server or in the cloud.

When the designer has completed work for the time being, they can log out of the system at stage 224. In one example, this can cause the VM to close. Alternatively, the VM can continue to execute for a period of time, such as one hour or one day, so that it need not be re-instantiated if the designer logs back in. At stage 226, the licenses can be deallocated. This can allow a shared license to be allocated to a different designer. The licensing server can track license allocations so that the same license is not used concurrently except when allowed by the licensor. The VM or licensing server can also update billing information at stage 228, based on the amount of time spent by the designer in a particular application that opened a specific project. Alternatively, time can be billed based on the designer's continuous activity within the VM.

The system can track rates of the selected designer and also the cumulative amount of time the designer has spent on the project. Based on the agreed upon payment terms, the customer will pay the system owner or manager the amounts due. In turn, the system can pay the designer for the amount of time spent on the system, based on the internal hourly rate between the system and the designer. This internal hourly rate can be maintained in the designer profile, in one example. The system billing system can allow the designer to login and see all hours spent on respective projects. The console can also sort this information by customer, showing the amounts due for each customer. Preferred payment method to the designer can also be part of the designer profile.

At stage 230, the customer device can log into the licensing server. This can cause the customer device to display a VM in one example. The customer's VM can be configured differently than the designer's VM, in an example. For example, the customer might not have access to all the same applications or full versions of those applications, to save on license allocation. For example, the customer may be able to open and view CAD or BIM files, but not edit them. But the customer can navigate to the project folder within the VM, and generally check on progress and billing.

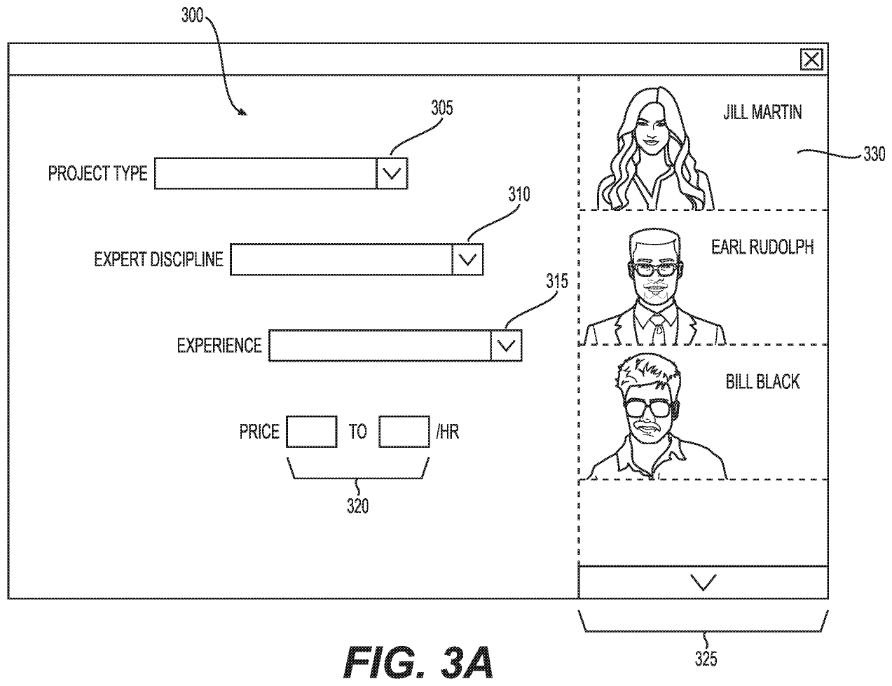

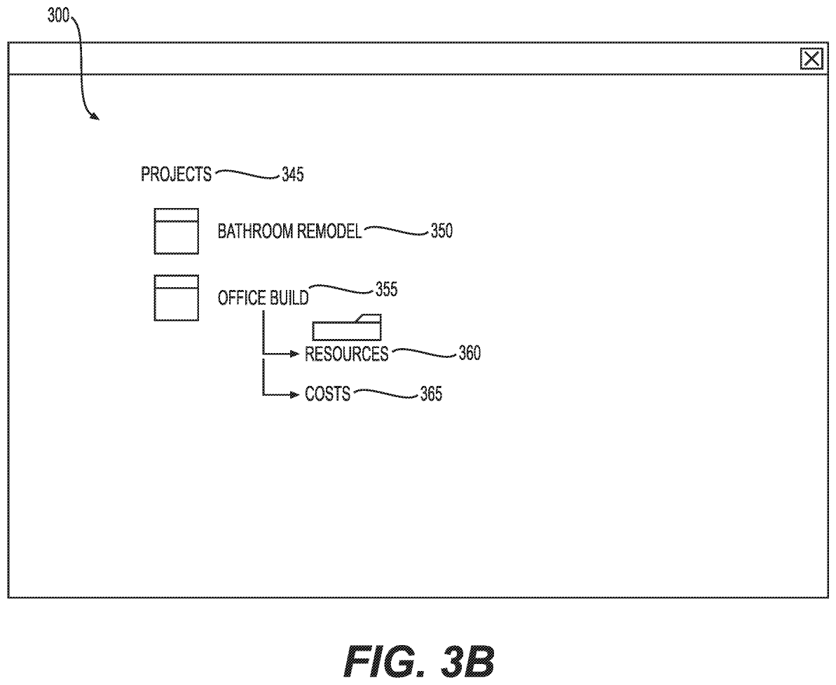

FIG. 3A is an example illustration of a GUI. The GUI can be displayed as part of an application or web interface that interacts with the licensing server.

The GUI can include a screen 300 that allows a customer to select requirements for a project. For example, the customer can select a designer (also called an expert). In this example, various selections are available. The customer can narrow down experts based on project type 305. The customer can further pick between different expert disciplines 310, such as architect, draftsman, engineer, and others. The customer can further narrow the search based on the expert's experience level 315, such as number of years, academic credentials, or professional certificates. Price 320 or a range of prices can also be specified. Other non-pictured selections can include available dates or date ranges.

The licensing server can compare these selections against designer profiles to generate a list 325 of potential experts. In one example, the customer can select between potential experts and get more detailed information. Once the customer is satisfied, they can select one or more experts that they approve for the project. For example, selection of Jill Martin 330 can add her to an existing or new project. Alternatively, the customer can arrange the list 325 as a ranked list by dragging preferred designers to the top and swiping rejected designers off of the screen 300. Then the licensing server can confirm that the expert accepts, starting with a highest ranked expert, in an example.

FIG. 3B includes an exemplary GUI used by either a customer or a designer. Screen 300, which can be a desktop of the VM, can display an associated project 345. In this example, two different projects 350, 355 are associated with the user. The project folders 345 and 355 can be further expanded in an example. Here, the office build project 355 can be expanded to review resources 360 and costs 365 for the project.

In one example, the projects 350, 355 each have project types. When a customer creates a project, the selected project type can be matched against project types of historical projects 350, 355 of designers. In one example, the more of a project type that a designer has completed, the higher ranking the match to that protect type will be.

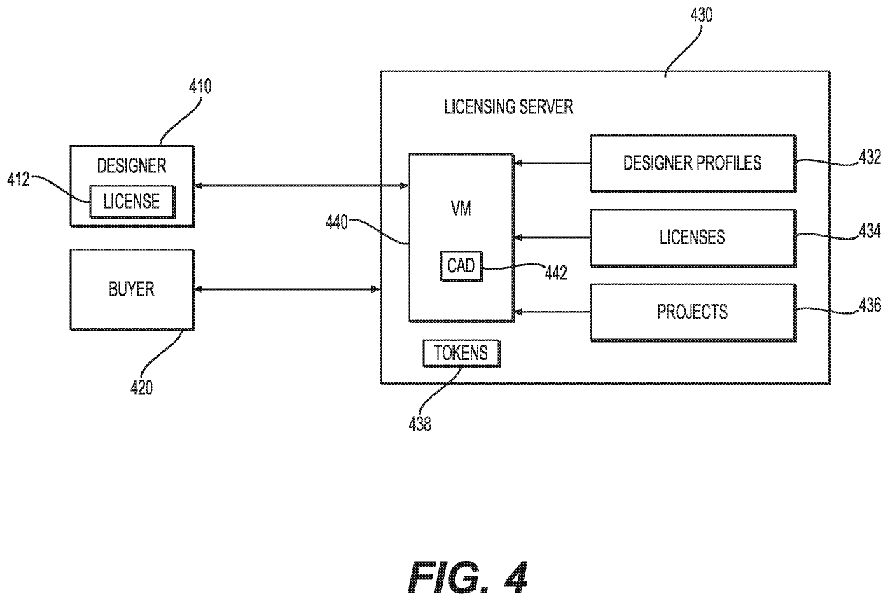

FIG. 4 is an exemplary illustration of system components. A licensing server 430 can communicate over a network, such as the internet, with a designer device 410 and a customer device 420. These devices are exemplary, and many designer and customer devices can communicate with the licensing server 430. These devices can be any processor-enabled device, such as a laptop, personal computer, tablet, or phone.

The licensing server 430 can store designer profiles 432. The designer profiles 432 can correspond to various designers that have enrolled in the system. The designer profiles 432 can include tokens 438 or pointers to tokens 438 for use in license allocation.

The licensing server 430 can also store customer profiles. The customer profiles can include projects created by the customer and requirements of those projects. Additionally, the customer profiles can include tokens 438 or pointers to tokens 438 for use in license allocation. The customer can allocate their own licenses to projects to reduce project costs, in an example.

The licensing server 430 can also store licenses 434 to share amongst users. Various licenses 434 can be allocated for running certain software. Additionally, per VM licenses can be shared such that when an inactive or logged out user's VM is terminated, the VM license can be used to instantiate a VM for a different user.

In one example, the designer can provide and use its own license 412. This can help a designer avoid paying for license 434 time for a license 412 they already have.

Additionally, the licensing server 430 can track projects 436. This can include associating designers and customers (buyers) with the various projects 436. A project 436 can have more than one customer and/or more than one designer assigned to it.

The licensing server 430 can instantiate multiple VMs 440 in one example. Each VM 440 can be configured according to particular project needs. For example, project types across all of a user's projects can dictate which applications are loaded on the VM 440. In the illustrated example, a CAD application 442 is loaded on the VM 440. The CAD application 442 can use a license 434 allocated by the licensing server 430. In another example, a BIM application can be loaded. In still another example, different versions of the applications can be loaded, based on different project needs. For example, different project types or different licensing lists can be approved by the customer.

The VM 440 can execute on a cloud server or on the licensing server 434 itself, depending on the example. The VM 440 can be instantiated based on the particular configuration for that project, with the appropriate application licenses and functionality. When the VM 440 is closed, the licenses can be reallocated. The VM 440 can close when a designer logs out, in an example, or after a period of time has passed without the designer logging back in.

The licensing server 430 can be hosted in the cloud and can include more than one server. Similarly, processors described herein may include one or more processors, each configured to execute instructions and process data to perform one or more functions associated with the system. The term “processor,” as generally used herein, refers to any logic processing unit, such as one or more central processing units (CPUs), digital signal processors (DSPs), application specific integrated circuits (ASICs), field programmable gate arrays (FPGAs), and similar devices.

Other embodiments of the invention will be apparent to those skilled in the art from consideration of the specification and practice of the invention disclosed herein. It is understood that the examples can operate as an application or plugin with REVIT or any other BIM or CAD program. Also, the terms part, component, and assembly are used interchangeably. It is intended that the specification and examples be considered as exemplary only, with a true scope and spirit of the invention being indicated by the following claims.

What is claimed is:

1. A system for virtualizing computer-aided design (“CAD”), including:
a non-transitory, computer-readable medium containing instructions;
a processor that executes the instructions to perform stages comprising:
receiving requirements for a project from a customer device, the requirements being selected on a GUI;
sending designer options for display in the GUI, the designer options based on matching the requirements against stored designer profiles;
based on receiving a selection from the designer options, creating a project that is assigned to the customer and a designer;
based on the designer logging in, instantiating a virtual machine (“VM”) that has access to the project, the VM being configured to include a first application based on a project type of the project;
allocating an available license to the VM for running the application; and
when the designer logs out, deallocating the license from use with the VM.

2. The system of claim 1, wherein the designer profile includes rates, skills, certifications, experience, and availability, and wherein the received requirements are matched against availability and at least one other type of information included in the designer profile.

3. The system of claim 1, the stages further comprising:
tracking designer time spent in the VM; and
saving billing information to the project based on tracked time and the designer rate.

4. The system of claim 1, wherein the license is allocated by time of use and the customer is charged for the designer's use of the license.

5. The system of claim 1, the stages further comprising:
receiving a token from the designer device that includes license information of a license selected at the designer device; and
allocating the selected license to the VM by sending the token to the VM.

6. The system of claim 1, the stages further comprising:
receiving a login by a customer device;
providing the customer device with access to the project based on the association of the customer with the project; and
preventing the customer device from accessing other projects that lack association with the customer.

7. The system of claim 7, wherein the VM displays a desktop on the designer device and allows the designer to navigate a project folder tree associated with the project.

8. A method for providing virtualized computer-aided design (“CAD”), comprising:
receiving requirements for a project from a customer device, the requirements being selected on a GUI;
sending designer options for display in the GUI, the designer options based on matching the requirements against stored designer profiles;
based on receiving a selection from the designer options, creating a project that is assigned to the customer and a designer;
based on the designer logging in, instantiating a virtual machine (“VM”) that has access to the project, the VM being configured to include a first application based on a project type of the project;
allocating an available license to the VM for running the application; and
when the designer logs out, deallocating the license from use with the VM.

9. The method of claim 8, wherein the designer profile includes rates, skills, certifications, experience, and availability, and wherein the received requirements are matched against availability and at least one other type of information included in the designer profile.

10. The method of claim 8, further comprising:
tracking designer time spent in the VM; and
saving billing information to the project based on tracked time and the designer rate.

11. The method of claim 8, wherein the license is allocated by time of use and the customer is charged for the designer's use of the license.

12. The method of claim 8, the stages further comprising:
receiving a token from the designer device that includes license information of a license selected at the designer device; and
allocating the selected license to the VM by sending the token to the VM.

13. The method of claim 8, further comprising:
receiving a login by a customer device;
providing the customer device with access to the project based on the association of the customer with the project; and
preventing the customer device from accessing other projects that lack association with the customer.

14. The method of claim 13, wherein the VM displays a desktop on the designer device and allows the designer to navigate a project folder tree associated with the project.

15. A non-transitory, computer-readable medium containing instructions for virtualizing computer-aided design (“CAD”), the instructions causing a processor to execute stages comprising:
receiving requirements for a project from a customer device, the requirements being selected on a GUI;
sending designer options for display in the GUI, the designer options based on matching the requirements against stored designer profiles;
based on receiving a selection from the designer options, creating a project that is assigned to the customer and a designer;
based on the designer logging in, instantiating a virtual machine (“VM”) that has access to the project, the VM being configured to include a first application based on a project type of the project;
allocating an available license to the VM for running the application; and
when the designer logs out, deallocating the license from use with the VM.

16. The non-transitory, computer-readable medium of claim 15, wherein the designer profile includes rates, skills, certifications, experience, and availability, and wherein the received requirements are matched against availability and at least one other type of information included in the designer profile.

17. The non-transitory, computer-readable medium of claim 15, the stages further comprising:
tracking designer time spent in the VM; and
saving billing information to the project based on tracked time and the designer rate.

18. The non-transitory, computer-readable medium of claim 15, wherein the license is allocated by time of use and the customer is charged for the designer's use of the license.

19. The non-transitory, computer-readable medium of claim 15, the stages further comprising:
receiving a token from the designer device that includes license information of a license selected at the designer device; and
allocating the selected license to the VM by sending the token to the VM.

20. The non-transitory, computer-readable medium of claim 15, the stages further comprising:
receiving a login by a customer device;
providing the customer device with access to the project based on the association of the customer with the project; and
preventing the customer device from accessing other projects that lack association with the customer.
